(19) United States
(12) Patent Application Publication
(10) Pub. No.: US 2021/0239205 A1
(43) Pub. Date: Aug. 5, 2021

(54) HYDRAULIC ACTUATING DEVICE FOR TRANSMISSION SHIFTING ELEMENT

(71) Applicant: ZF FRIEDRICHSHAFEN AG, Friedrichshafen (DE)

(72) Inventors: Florian Weinl, Bodolz (DE); Julia Stecher, Friedrichshafen (DE); Bernard Hunold, Friedrichshafen (DE); Karsten Kudermann, Reichenau (DE); Matthias Köpf, Ravensburg (DE)

(73) Assignee: ZF FRIEDRICHSHAFEN AG, Friedrichshafen (DE)

(21) Appl. No.: 17/050,705

(22) PCT Filed: Mar. 19, 2019
(86) PCT No.: PCT/EP2019/056850

§ 371 Date: Oct. 26, 2020

(30) Foreign Application Priority Data
Apr. 24, 2018 (DE) 10 2018 206 275.7

(51) Int. Cl. F16H 61/02; F16H 61/00; F16H 63/30

(52) U.S. Cl. CPC F16H 61/0267; F16H 63/3023; F16H 61/0276; F16H 61/0025

(57) ABSTRACT

A hydraulic actuating device for actuating a shifting element of a transmission includes a hydraulic cylinder with a piston rod and a piston chamber, wherein the piston rod can be brought into a mechanical operative connection with the shifting element, and a hydraulic pump which is connected via a hydraulic line to the piston chamber, in order for it to be possible for hydraulic fluid to be fed to the piston chamber and thus to initiate an adjusting movement of the piston rod. The actuating device is characterized by a shut-off device, via which the hydraulic fluid can be locked in the piston chamber, in order thus to fix the position of the piston rod.

### CROSS-REFERENCE TO RELATED APPLICATION

This application is a national stage of International Application No. PCT/EP2019/056850, filed Mar. 19, 2019, the disclosure of which is incorporated herein by reference in its entirety, and which claimed priority to German Patent Application No. 102018206275.7, filed Apr. 24, 2018, the disclosure of which is incorporated herein by reference in its entirety.

### TECHNICAL FIELD

The present disclosure relates to a hydraulic actuating device for actuating a shifting element of a transmission. The present disclosure furthermore relates to a method for actuating a shifting element for a transmission using an actuating device of said type.

### BACKGROUND

Modern motor vehicle transmissions have a large number of shifting elements which can be actuated by means of hydraulic systems. The hydraulic actuation makes high shifting forces and short shifting times possible. Here, the hydraulic systems commonly comprise a double-acting cylinder which can be charged with hydraulic fluid by means of a pump with two conveying directions. The pump is driven by means of a motor. The double-acting cylinder may in turn be connected to a shifting rod or shifting sleeve which is in engagement with the shifting element. By operation of the motor and thus of the pump, the cylinder is charged with hydraulic fluid, and the shifting element is thus actuated. It is commonly desirable to fix the shifting element in a particular position in order to thus prevent an undesired movement. If the shifting element is for example a clutch, an undesired gearchange can be prevented by means of the fixing action. To fix the position of the shifting element, DE 10 2011 107 263 A1 proposes the provision of a mechanical blocking element which can, by means of a spring, be placed in engagement with grooves provided on the shifting rod.

### SUMMARY

The present disclosure relates to a hydraulic actuating device for actuating a shifting element of a transmission. The shifting element may be a positively engaging or a frictionally engaging clutch. For example, the shifting element is a dog clutch. The shifting element may likewise be an interlock for a parking lock, a transmission brake or some other transmission shifting element. The transmission may be a motor vehicle transmission, a utility vehicle transmission or some other transmission. An actuation of a shifting element is to be understood to mean the transfer of the shifting element into a state in which it can perform its shifting function. The hydraulic actuating device may for example be operated with hydraulic oil as hydraulic fluid.

The actuating device comprises a hydraulic cylinder with a piston rod and with a piston chamber. A piston chamber is to be understood to mean a chamber, the filling of which with hydraulic fluid can lead to a displacement of the piston rod. The hydraulic cylinder may be a single-acting cylinder with only one piston chamber. Filling of said piston chamber with hydraulic fluid can result in the initiation of a movement of the piston rod, wherein the return movement occurs owing to the inherent mass of the piston rod or owing to an external force, for example a spring force. Said hydraulic cylinder may likewise be a double-acting cylinder with two piston chambers. Filling of the first piston chamber with hydraulic fluid can result in the initiation of a movement of the piston rod in a first direction. Filling of the second piston chamber with hydraulic fluid can result in the initiation of a movement of the piston rod in an opposite, second direction. Likewise, the cylinder may be a plunger cylinder. The piston rod can be placed in mechanical operative connection with the shifting element. In the case of a mechanical operative connection of two elements, the movement of one element can initiate a movement of the other element.

Furthermore, the actuating device comprises a hydraulic pump, which is connected via a hydraulic line to the piston chamber of the hydraulic cylinder. The hydraulic pump may be driven by means of a motor, for example an electric motor. By means of the hydraulic pump, hydraulic fluid can be pumped into the piston chamber in order to thus effect an adjustment movement of the piston rod.

The actuating device furthermore comprises a shut-off means. Using the shut-off means, a hydraulic fluid which is situated in the piston chamber of the hydraulic cylinder can be confined. A confinement of the hydraulic fluid in the piston chamber is to be understood to mean the establishment of a state in which the piston chamber is closed off to the outside. In this state, no hydraulic fluid whatsoever can enter the piston chamber, and escape therefrom, aside from leakage.

By confinement of the hydraulic fluid in the piston chamber, the piston rod and a shifting element connected therewith can be arrested, that is to say spatially fixed. The hydraulic actuating device of the present disclosure in this case permits simple and inexpensive arresting of the piston rod, because no mechanical arresting elements are necessary. It is thus possible, for example, to use inexpensive materials for the piston rod, which do not have to withstand any high mechanical arresting forces. Furthermore, through the omission of the mechanical arresting element, a particularly compact actuating device can be provided.

The actuating device of the present disclosure furthermore permits simple and exact actuation without elevated-thrust profiles. If one considers a force that is required to move an element along a path, an elevated-thrust profile has an increased force at the start of the path, for example for the breakaway of the element. Elevated-thrust profiles may be encountered in the case of mechanical arresting elements upon the movement away from the neutral position. Furthermore, the present actuating device permits continuously variable setting of an arresting position, which in turn permits compensation of wear and other perturbations. Ultimately, the actuating device of the present disclosure exhibits high energy efficiency, because no force shocks are necessary to overpower the arresting action in the neutral position. Likewise, the functional reliability is high, because no arresting element is present whose freedom of movement can be impaired by external forces.

The shut-off means may have a valve with a pass-through position and a shut-off position. In the pass-through position, the valve allows hydraulic fluid to pass through, and the throughflow is prevented in the shut-off position. The valve of this embodiment is provided in the hydraulic line between the hydraulic pump and the piston chamber. If the valve is in the shut-off position, the fluid connection between pump and piston chamber is shut off, and the fluid is confined in the piston chamber. If the valve is transferred into the open position, the piston chamber can, by contrast, be filled with hydraulic fluid by means of the hydraulic pump. The valve may be situated in the shut-off position when in the rest state. The rest state may be a state in which the valve is not subject to any force or energy. Consequently, a hydraulic fluid can be confined in the piston chamber in the rest state. This allows arresting of the piston rod with a high level of fail safety, because the arresting action is independent of an application of energy to the actuating device. By contrast, by application of energy to the valve, the latter can be transferred into the open position. The valve may be a simple and inexpensive switching valve, for example an electromagnetically or hydraulically unblockable check valve.

Furthermore, the hydraulic cylinder may be a double-acting cylinder with two piston chambers. By means of the hydraulic pump, hydraulic fluid can be fed either to the first or to the second piston chamber in order to thus allow a movement of the piston rod in a first or an opposite second movement direction, as described above. By means of the shut-off means, the hydraulic fluid can be confined in the first piston chamber and second piston chamber, such that the position of the piston rod is fixed.

The shut-off means may have a first and a second valve each with a pass-through and a shut-off position. The first valve may be provided in a hydraulic line between the hydraulic pump and the first piston chamber. The second valve may be provided in a hydraulic line between the same or a second hydraulic pump and the second piston chamber. The provision of two valves makes it possible for the line to the first piston chamber to be arranged and designed independently of the line to the second piston chamber. As a result, it is thus possible for a more compact actuating device to be provided, because the individual valves and lines can be arranged in a manner optimized in terms of position. The first and the second valve may be coupled to one another by means of a coupling element, such that these can be transferred into the pass-through position and the shut-off position only jointly. It is thus the case that only one valve actuation means and only one resetting means is required for both valves, leading to a saving of components. Furthermore, synchronous operation of both valves can thus be provided.

Alternatively, the shut-off means may have a single valve with a pass-through position and a shut-off position. The single valve may be provided in the hydraulic lines between the hydraulic pump and the first piston chamber and second piston chamber. More specifically, both the hydraulic line that leads from the hydraulic pump to the first piston chamber and the hydraulic line that leads from the hydraulic pump to the second piston chamber may run by the single shut-off valve. If the single shut-off valve is transferred into the shut-off position, it is thus possible for a fluid to be confined in the first piston chamber and second piston chamber and for the piston rod to thus be arrested. This embodiment leads to a simple configuration, because only one valve is required.

In the context of one embodiment, the single valve may have not only the pass-through position and the shut-off position but also a connecting position. In the connecting position, the first piston chamber and second piston chamber are connected to one another, such that any pressure difference can be equalized. Furthermore, in the connecting position, the first piston chamber and second piston chamber are connected via a hydraulic line to the hydraulic pump. Consequently, by means of the hydraulic pump, a hydraulic fluid can be conveyed into the first piston chamber and second piston chamber simultaneously. Leakage compensation can thus be performed. If the leakage flows of both chambers are approximately identical, the hydraulic lines between the valve and the respective chambers may have the same cross sections. Such a situation may arise for example in the neutral position of the piston in the center of the cylinder and in the end positions.

Furthermore, the present disclosure relates to a shifting means having a shifting element for a transmission and having a hydraulic actuating device according to any of the embodiments described above for actuating the shifting element. With regard to the understanding of the individual features and the advantages thereof, reference is made to the statements above.

The present disclosure furthermore relates to a method for actuating a shifting element for a transmission. The method uses a hydraulic actuating device according to any of the embodiments described above. The method comprises feeding hydraulic fluid to the piston chamber by means of the hydraulic pump in order to adjust the piston rod. Furthermore, the method comprises transferring the shut-off device into a shut-off position in order to confine the hydraulic fluid in the piston chamber and fix the position of the piston rod. With regard to the understanding of the individual features and the advantages thereof, reference is made to the statements above.

The method may furthermore comprise building up pressure in the hydraulic line by means of the hydraulic pump. After the pressure has been built up, the shut-off means can be transferred into a pass-through position. As a result of the increase of the pressure before the transfer of the shut-off means into the pass-through position, a backflow of hydraulic fluid from the piston chamber into the hydraulic line can be prevented. These method steps may be performed for example if, when the piston chamber is shut-off, a deviation of the piston rod from a setpoint position is detected, and a renewed position adjustment is required. Such a deviation may arise for example as a result of leakage. With regard to the understanding of the individual features and the advantages thereof, reference is made to the statements above.

If the hydraulic cylinder is a double-acting cylinder with a first and a second piston chamber, the method may furthermore comprise connecting the first piston chamber and the second piston chamber to one another and to the hydraulic pump. It is thus possible for an exchange of hydraulic fluid between the first piston chamber and second piston chamber to occur, for example in order to equalize pressure differences between the chambers. Furthermore, the method may comprise conveying a hydraulic fluid by means of the hydraulic pump into the first piston chamber and second piston chamber for the compensation of leakage. By means of such leakage compensation, a position deviation of the piston rod from a setpoint position can be prevented.

### BRIEF DESCRIPTION OF THE FIGURES

FIG. 1 shows a schematic view of a hydraulic actuating device according to a first embodiment of the present disclosure.

FIG. 2 shows a schematic view of a hydraulic actuating device according to a second embodiment of the present disclosure.

FIG. 3 shows a detail of a schematic view of a hydraulic actuating device according to a third embodiment of the present disclosure.

FIG. 4 shows a flow diagram of a method for actuating a shifting element according to an embodiment of the present disclosure.

### DETAILED DESCRIPTION

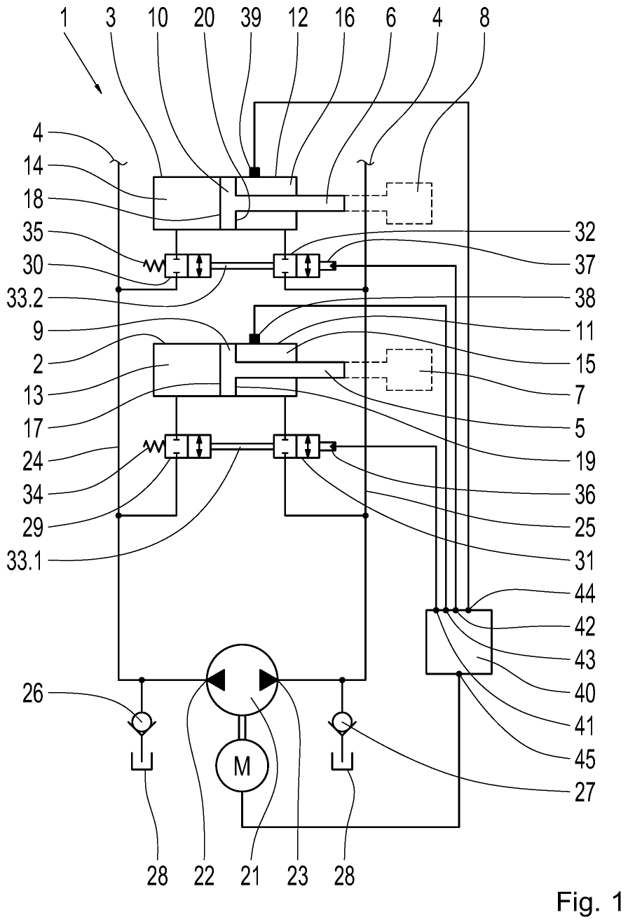

FIG. 1 shows a hydraulic actuating device 1 according to a first embodiment of the present disclosure. The actuating device 1 comprises a first hydraulic cylinder 2 and a second hydraulic cylinder 3. Furthermore, the actuating device 1 may have further hydraulic cylinders, as can be seen from the truncations 4 in FIG. 1. In this embodiment, the hydraulic cylinders 2, 3 are each double-acting cylinders. The cylinders 2, 3 each comprise a piston rod 5, 6, which is operatively connected to a shifting element 7, 8. The shifting elements 7, 8 are illustrated merely schematically in FIG. 1. The piston rods 5, 6 are each fixedly attached to a piston 9, 10, which is provided in displaceable fashion in a housing 11, 12. Displacement of the piston 9, 10 in the housing 11, 12 causes the piston rod 5, 6 attached thereto to be displaced, whereby the respective shifting element 7, 8 can be actuated.

The hydraulic cylinders 2, 3 each have a first piston chamber 13, 14, which is provided on that side of the piston 9, 10 which is averted from the piston rod 5, 6. The first piston chamber 13, 14 adjoins a first piston surface 17, 18 of the piston 9, 10, which first piston surface is in this case circular. Furthermore, the hydraulic cylinders 2, 3 each have a second piston chamber 15, 16, which is formed as a space with a ring-shaped cross section around the respective piston rod 5, 6. The second piston chamber 15, 16 adjoins a second piston surface 19, 20 of the piston 9, 10, which second piston surface is in this case of circular-ring-shaped form. The respective volume of the individual piston chambers 13, 14, 15, 16 is dependent on the position of the piston 9, 10 within the housing 11, 12.

Furthermore, the actuating device 1 comprises a hydraulic pump 21, which can be driven by means of a motor M. The hydraulic pump 21 has a first interface 22 and a second interface 23. The hydraulic pump 21 is, in the present embodiment, configured with an adjustable conveying direction, wherein the conveying direction can be set by means of the direction of rotation of the motor M. If the motor rotates in a first direction, the first interface 22 functions as pump inlet and the second interface 23 functions as pump outlet. If the motor M rotates in the opposite direction, the first interface 22 functions as pump outlet and the second interface 23 functions as pump inlet.

The first interface 22 of the pump 21 is connected via a first hydraulic line 24 to the first piston chambers 13, 14 of the hydraulic cylinders 2, 3. Furthermore, the second interface 23 of the pump 21 is connected via a second hydraulic line 25 to the second piston chambers 15, 16 of the hydraulic cylinders 2, 3. The hydraulic lines 24, 25 are each connected via a check valve 26, 27 to a tank 28. Volume flow which is absent owing to leakage can thus be replenished into the system from the tank 28 via the check valves 26, 27.

In this embodiment, the first piston chamber 13 of the first hydraulic cylinder 2 and the first piston chamber 14 of the second hydraulic cylinder 3 are each connected via a first 2/2 directional valve 29 and 30 respectively to the first interface 22 of the pump 21. The connection is realized by the first hydraulic line 24. Furthermore, the second piston chamber 15 of the first hydraulic cylinder 2 and the second piston chamber 16 of the second hydraulic cylinder 3 are each connected via a second 2/2 directional valve 31 and 32 respectively to the second interface 23 of the pump 21. The connection is realized by the second hydraulic line 25.

The 2/2 directional valves 29, 30, 31, 32 each have a pass-through position and a shut-off position. The first valve 29 and second valve 31 of the first hydraulic cylinder 2 are coupled to one another via a first coupling element 33.1. Furthermore, the first valve 30 and second valve 32 of the second hydraulic cylinder 3 are coupled to one another via a second coupling element 33.2. Owing to the coupling element 33.1, 33.2, the coupled valves 29, 31 and 30, 32 respectively are always situated in the same position, that is to say either in the pass-through position or in the shut-off position.

The respective first valve 29, 30 of the first hydraulic cylinder 2 and second hydraulic cylinder 3 has in each case a resetting spring 34, 35, by means of which the respective valve 29, 30 is transferred into the shut-off position when not actuated. The respective resetting spring 34, 35 also, via the respective coupling element 33.1, 33.2, transfers the respective second valve 31, 32 of the first hydraulic cylinder 2 and second hydraulic cylinder 3 into the shut-off position. Accordingly, in the rest state, all valves 29, 30, 31, 32 are situated in the shut-off position. Furthermore, the respective second valve 31, 32 of the first hydraulic cylinder 2 and second hydraulic cylinder 3 has an electromagnetic activation means 36, 37, by which the respective valve 31, 32 can be transferred into the pass-through position. Via the respective coupling element 33.1, 33.2, the respective first valve 29, 30 of the first hydraulic cylinder 2 and second hydraulic cylinder 3 can also be transferred into the pass-through position by the respective electromagnetic activation means 36, 37.

Furthermore, in the first hydraulic cylinder 2 and in the second hydraulic cylinder 3, there is provided in each case a position sensor 38 and 39 respectively, by means of which the actual position of the piston 9 and 10 respectively can be ascertained.

The actuating device 1 furthermore comprises a control means 40 with a first valve interface 41 and a second valve interface 42. The valve interfaces 41, 42 are connected to the respective electromagnetic actuation means 36, 37 of the first hydraulic cylinder 2 and second hydraulic cylinder 3 respectively. Furthermore, the control means comprises a first position interface 43 and a second position interface 44, which is connected to the first position sensor 38 and second position sensor 39 respectively. Finally, the control means 40 comprises a motor interface 45, which is connected to the motor M.

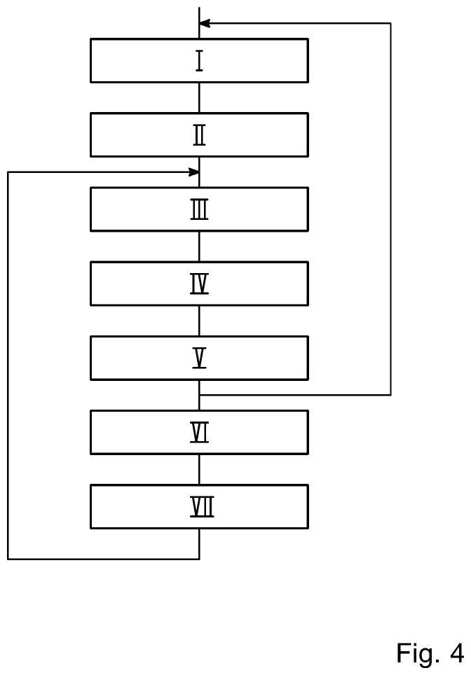

The control means 40 is configured to carry out the method described below with reference to FIG. 4. In a first step I, firstly, the system pressure is increased by means of the motor M and the pump 21 via the motor interface 45. Here, the pressure increase is performed to such an extent that, upon the transfer of the valves 29, 31 into the pass-through position, a backflow from the piston chambers 13, 15 into the hydraulic lines 24, 25 can be prevented. Subsequently, the first valve 29 and the second valve 31 of the first hydraulic cylinder 2 are transferred into the pass-through position by virtue of the first activation means 36 being actuated via the first valve interface 41. The valves 30, 32 of the further hydraulic cylinders 3 are situated in the shut-off position.

Subsequently, in a step II, by operation of the motor M and thus of the pump 21 via the motor interface 45, the piston 9 of the first hydraulic cylinder 2 is transferred into a setpoint position. For this purpose, hydraulic fluid is pumped into the first piston chamber 13 or second piston chamber 15, depending on the setpoint position of the piston 9, by means of the pump 21. The hydraulic fluid acts on the respective piston surface 17, 19 and initiates a displacement of piston 9 and piston rod 5. The actual position of the piston 9 is monitored by means of the position sensor 38 and the position interface 43. The motor M is controlled on the basis of the actual position detected by means of the position sensor 38.

As soon as the piston 9 has reached the setpoint position, the electrical energization of the first activation device 36 is ended in a following step III. Accordingly, the first valve 29 and second valve 31 of the first hydraulic cylinder 2 are transferred into the shut-off position by means of the resetting spring 34. In the shut-off position, the hydraulic fluid is confined in the first piston chamber 13 and second piston chamber 15. As a result, the position of the piston 9 and thus of the piston rod 5 is fixed.

The piston position may however vary owing to leakage, for example. Therefore, in a step IV, the position of the piston 9 in the confined state is monitored by means of the position sensor 38 and the position interface 41. As soon as a deviation from the setpoint position is detected, in a step V, the system pressure is increased by means of the motor M and the pump 21 via the motor interface 45. Here, the pressure increase is likewise performed to such an extent that, upon the transfer of the valves 29, 31 into the pass-through position, a backflow from the piston chambers 13, 15 into the hydraulic lines 24, 25 can be prevented. The method subsequently returns to step I, in order to adjust the position of the piston 2 to the setpoint position again. The method described above may be performed subsequently for the second hydraulic cylinder 3.

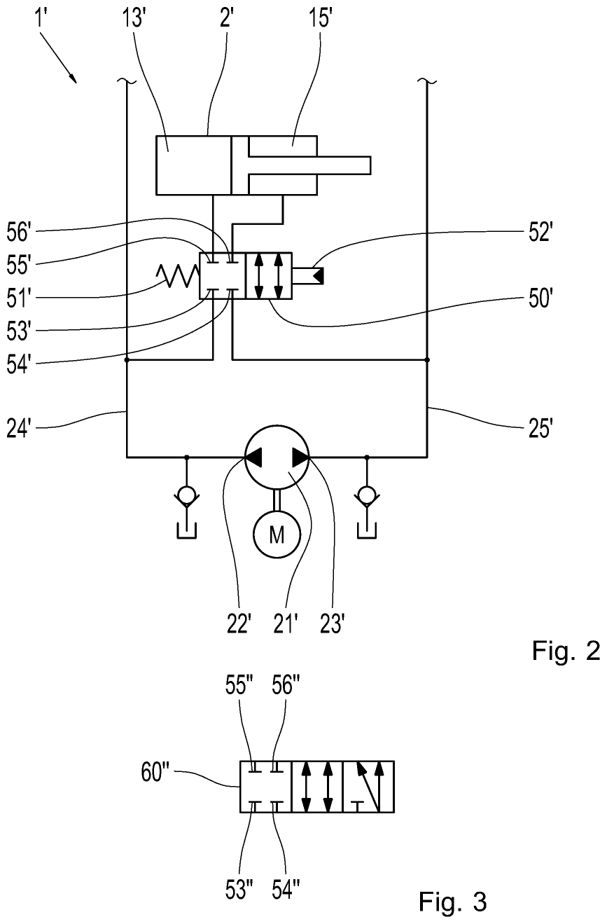

FIG. 2 shows a schematic view of a hydraulic actuating device 1′ according to a second embodiment of the present disclosure. The configuration of the actuating device 1′ shown in FIG. 2 corresponds to the configuration of the actuating device 1 from FIG. 1 with the exception of the differences described below. The actuating device 1′ from FIG. 2 has a 4/2 directional valve 50′ instead of a first and a second 2/2 directional valve which are coupled to one another by means of a coupling element. The 4/2 directional valve has a throughflow position and a shut-off position. Analogously to the 2/2 directional valves from FIG. 1, the 4/2 directional valve has a resetting spring 51′, by means of which the valve 50′ is transferred into the shut-off position in the rest state. Likewise, the valve 50′ comprises an electromagnetic activation means 52′ by means of which the valve 50′ can be transferred into the pass-through position. The activation means 52′ may also be formed as an electromotive and/or hydraulic activation means.

The 4/2 directional valve comprises a first inlet 53′ which is connected via the first hydraulic line 24′ to the first interface 22′ of the pump 21′. Furthermore, the 4/2 directional valve has a second inlet 54′, which is connected via the second hydraulic line 25′ to the second interface 23′ of the pump 21′. Furthermore, the valve 50′ comprises a first outlet 55′, which is connected to the first piston chamber 13′, and a second outlet 56′, which is connected to the second piston chamber 15′ of the cylinder 2′. If the 4/2 directional valve is transferred into the throughflow position, the first inlet 53′ is connected to the first outlet 55′ and the second inlet 54′ is connected to the second outlet 56′. A fluidic connection is thus produced between the first piston chamber 13′ and the first interface 22′ and between the second piston chamber 15′ and the second interface 23′ of the pump 21′. If the 4/2 directional valve is situated in the shut-off position, these fluidic connections are shut off, such that the hydraulic fluid is confined in each case in the first piston chamber 13′ and in the second piston chamber 15′.

Although only one hydraulic cylinder 2′ is shown in FIG. 2, it is likewise possible for multiple cylinders to be provided as in the embodiment from FIG. 1. The individual hydraulic cylinders may have in each case one 4/2 directional valve, as shown in FIG. 2, or two 2/2 directional valves, as shown in FIG. 1. The control means (not shown) of the second embodiment is configured to carry out the method described with reference to FIG. 1, wherein, in this second embodiment, the 4/2 directional valve 50′ is controlled.

FIG. 3 shows a detail of a schematic view of a hydraulic actuating device according to a third embodiment of the present disclosure. The configuration of the third embodiment corresponds to the configuration of the second embodiment with the exception of the differences described below. By contrast to the second embodiment, the actuating device of the third embodiment has a 4/3 directional valve 60″. In addition to the throughflow position and the closed position, the valve 60″ of the third embodiment has a connecting position. In the connecting position, one of the inlets 53″ or 54″ is connected to both outlets 55″ and 56″ of the valve 60″. Accordingly, the first chamber and second chamber of the hydraulic cylinder are connected to one another by means of the 4/3 directional valve 60″. Furthermore, the two chambers of the hydraulic cylinder are connected by means of the 4/3 directional valve 60″ to the first or second interface of the pump.

The control means (not shown) of the third embodiment is configured to carry out the method described with reference to FIG. 1, wherein, in this third embodiment, the 4/3 directional valve 60″ is controlled. Furthermore, the control means of the third embodiment is configured to transfer the valve 60″ into the connecting position in a step VI after the pressure increase in the system in step V. In a step VII, the pump conveys a hydraulic fluid flow into both piston chambers in order to thus perform leakage compensation. As soon as the piston has reached the setpoint position, the method returns to step III.

1. A hydraulic actuating device for actuating a shifting element of a transmission comprising:
a hydraulic cylinder with a piston rod and with a piston chamber, wherein the piston rod can be placed in mechanical operative connection with the shifting element; and
a hydraulic pump, which is connected via a hydraulic line to the piston chamber in order to be able to feed hydraulic fluid to the piston chamber and thus initiate an adjustment movement of the piston rod;
wherein the actuating device furthermore has a shut-off means by which a hydraulic fluid can be confined in the piston chamber in order to thus fix the position of the piston rod.

2. The hydraulic actuating device as defined in claim 1 wherein the shut-off means has a valve with a pass-through position and a shut-off position, the valve being disposed in the hydraulic line between the hydraulic pump and the piston chamber, and wherein the valve is situated in the shut-off position when in the rest state.

3. The hydraulic actuating device as defined in claim 2, wherein the hydraulic cylinder is a double-acting cylinder with a first piston chamber and a second piston chamber, and wherein a hydraulic fluid can be confined in the first piston chamber and in the second piston chamber by means of the shut-off means.

4. The hydraulic actuating device as defined in claim 3, wherein the shut-off means has a first valve and a second valve which each have a pass-through position and a shut-off position, wherein the first valve is provided in a hydraulic line between the hydraulic pump and the first piston chamber and the second valve is provided in a hydraulic line between the hydraulic pump and the second piston chamber.

5. The hydraulic actuating device as defined in claim 3, characterized in that the shut-off means has a single valve with a pass-through position and a shut-off position, which valve is provided in the hydraulic lines between the hydraulic pump and the first piston chamber and second piston chamber.

6. The hydraulic actuating device as defined in claim 5, wherein the single valve furthermore has a connecting position in which the first piston chamber and second piston chamber are connected to one another and via a hydraulic line to the hydraulic pump.

7. (canceled)

8. A method for actuating a shifting element for a transmission using a hydraulic actuating device as defined in claim 6, comprising the steps of:
feeding hydraulic fluid to the piston chamber by means of the hydraulic pump in order to adjust the piston rod; and
transferring the shut-off means into a shut-off position in order to confine the hydraulic fluid in the piston chamber and fix the position of the piston rod.

9. The method as defined in claim 8, characterized in that the method furthermore comprises the steps of:
building up pressure in the hydraulic line by means of the hydraulic pump; and subsequently transferring the shut-off means into a pass-through position in order to feed hydraulic fluid to the piston chamber.

10. The method as defined in claim 9, wherein the hydraulic cylinder is a double-acting cylinder with a first piston chamber and a second piston chamber, characterized in that the method furthermore comprises the steps of:
connecting the first piston chamber and the second piston chamber to one another and to the hydraulic pump; and
conveying a hydraulic fluid by means of the hydraulic pump into the first piston chamber and second piston chamber for the compensation of leakage.
